(19) United States
(12) Patent Application Publication
(10) Pub. No.: US 2012/0088542 A1
(43) Pub. Date: Apr. 12, 2012

(54) METHOD CONSTRUCTION FOR REDUCING INTERFERENCE BETWEEN ANTENNA AND PERIPHERAL DEVICE

(75) Inventors: Min-Sung Choi, Seoul (KR); Chang-Ki Lee, Seoul (KR); Won-Ik Do, Seoul (KR)

(73) Assignee: SAMSUNG ELECTRONICS CO., LTD., Suwon-si (KR)

(21) Appl. No.: 13/167,799

(22) Filed: Jun. 24, 2011

(30) Foreign Application Priority Data
Oct. 12, 2010 (KR) 10-2010-0099107

(51) Int. Cl. H04W 88/02; H04B 1/10

(52) U.S. Cl. 455/554.2; 455/296

(57) ABSTRACT

A structure and method reduce interference between an antenna and a peripheral device. The structure includes an antenna module and a speaker module. The antenna module includes a carrier and the antenna attached to the carrier. The speaker module is mounted in the carrier and includes a speaker and a signal line electrically connected to the speaker. The structure changes at least one of a shape and a length of the signal line to secure a radiation performance of the antenna module.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office Oct. 12, 2010 on and assigned Serial No. 10-2010-0099107, the entire disclosure of which is hereby incorporated by reference.

### TECHNICAL FIELD OF THE INVENTION

The present invention relates to an antenna. More particularly, the present invention relates to a structure and a method for reducing interference between an antenna and a peripheral device in order to secure a radiation performance of the antenna.

### BACKGROUND OF THE INVENTION

Currently, with development of electronic communication industries, a mobile terminal such as a mobile communication terminal (cellular phone), an electronic scheduler, a personal digital assistant, and such, has become indispensable to a modern society, and plays an important role of transferring information that may change quickly. Under this circumstance, a mobile terminal provides additional functions and has a lightweight slim profile.

As more functions are added to a mobile terminal, it becomes even more difficult to mount lots of elements in a limited space while maintaining a lightweight slim profile. For example, an antenna space for radio wave transmission/reception has an excellent performance when the antenna space is large, but the space for mounting the antenna becomes narrow as more elements need to be added. In addition, interference with other factors makes it difficult for the antenna to secure a desired radiation performance.

### SUMMARY OF THE INVENTION

To address the above-discussed deficiencies of the prior art, it is a primary object to provide at least the advantages described below. Accordingly, an aspect of the present invention is to provide a structure and a method for reducing interference between an antenna and a peripheral device in order to prevent a radiation performance of the antenna from deteriorating under an influence of interference from the peripheral device.

Another aspect of the present invention is to provide a structure and a method for reducing interference between an antenna and a peripheral device in order to secure a radiation performance of the antenna by changing the shape and length of a signal line electrically connected to the peripheral device that interferes with the antenna.

Yet another aspect of the present invention is to provide a structure and a method for reducing interference between an antenna and a peripheral device in order to prevent a deterioration of radiation performance of the antenna that is attached together with a carrier into which a speaker is inserted.

Other aspects, advantages and salient features of the invention will become apparent to those skilled in the art from the following detailed description, which, taken in conjunction with the annexed drawings, discloses embodiments of the invention.

According to an embodiment, a structure for reducing interference between an antenna and a peripheral device is provided. The structure includes an antenna module and a speaker module. The antenna module includes a carrier and the antenna attached to the carrier. The speaker module is mounted in the carrier and includes a speaker and a signal line electrically connected to the speaker. A radiation performance of the antenna module is secured by changing at least one of a shape and a length of the signal line.

According to another embodiment, a structure for reducing interference between an antenna and a peripheral device is provided. The peripheral device is connected to a signal line for receiving a signal. The antenna is influenced by the peripheral device and is configured transmit and receive radio waves. The antenna changes a radiation performance as at least one of a shape and a length of the signal line changes.

According to yet another embodiment, a method for reducing interference between an antenna and a peripheral device is provided. At least one of a shape and a length of a signal line electrically connected to a speaker is changed. A signal to the speaker is provided to secure a radiation performance of the antenna.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain embodiments of the present invention will be more apparent from the following description taken in conjunction with the accompanying drawings in which:

FIG. 1 is a perspective view of a mobile terminal according to an embodiment of the present invention;

FIG. 2 is a view of a structure for reducing interference between an antenna and a peripheral device according to an embodiment of the present invention; and

FIGS. 3A, 3B and 3C are graphs that measure a Standing Wave Ratio (SWR) of a relevant antenna module depending on a length change of a signal line (feed line) of a speaker and a table comparing antenna performances.

Throughout the drawings, like reference numerals will be understood to refer to like parts, components and structures.

### DETAILED DESCRIPTION OF THE INVENTION

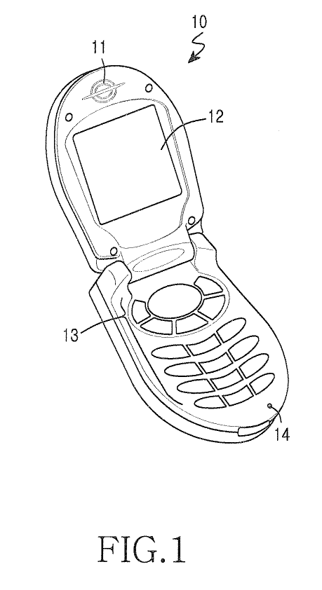

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. The following description with reference to the accompanying drawings is provided to assist in a comprehensive understanding of embodiments of the invention as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention are provided for illustrative purposes only and not for limiting the invention, as defined by the appended claims and their equivalents.

Embodiments of the present invention provide a structure and a method for securing a radiation performance of an antenna, and more particularly, provide a structure and a method for reducing interference between an antenna and a peripheral device.

FIG. 1 is a perspective view of a mobile terminal according to an embodiment of the present invention.

Referring to FIG. 1, the mobile terminal 10 includes a speaker 11 for outputting sound such as a voice signal, and a display 12 located below the speaker 11, for outputting a video signal. More particularly, the mobile terminal 10 includes a keypad assembly 13 that serves as a data input unit, and a microphone 14 located below the keypad assembly 13, for inputting a voice signal. The display 12 may be a Liquid Crystal Display (LCD) with millions of pixels. In addition, when a touch screen is provided to the LCD, the display 12 may perform the function of the data input unit as an auxiliary unit or in substitution for the keypad assembly 13.

In addition, the mobile terminal 10 has an antenna (not shown) for transmitting/receiving a radio wave. The antenna is attached to a carrier with the same insulation as that of the speaker 11. The antenna and the speaker 11 are electrically connected to a main board of the mobile terminal. More particularly, the speaker 11 is electrically connected to the main board of the mobile terminal by the medium of a signal line. That is, the mobile terminal 10 includes an antenna module including a carrier 22, an antenna 21 attached to the carrier 22, and a speaker module including the speaker 11 and a signal line electrically connected to the speaker 11. The speaker module is coupled to the antenna module. Hereinafter, this construction is denoted by a ‘speaker antenna module’.

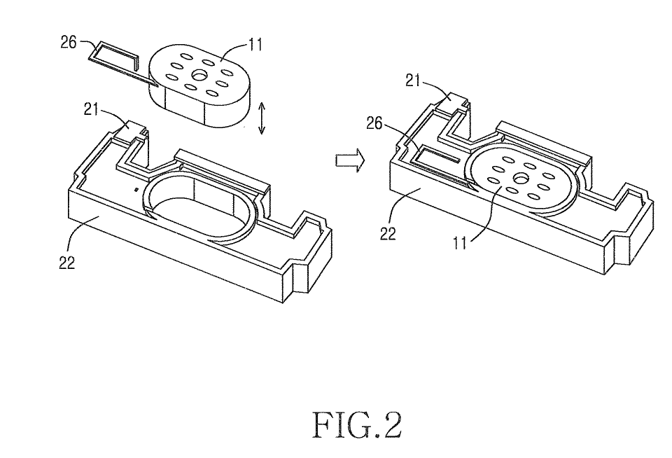

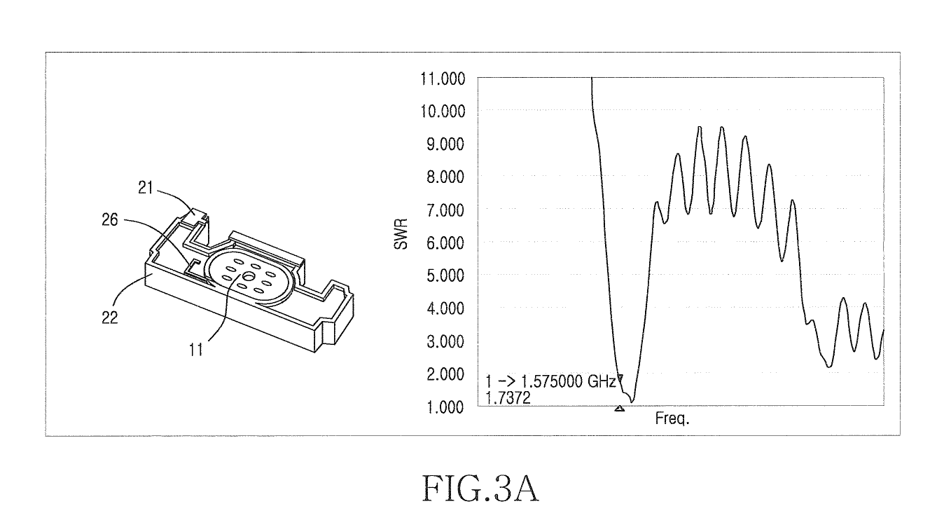

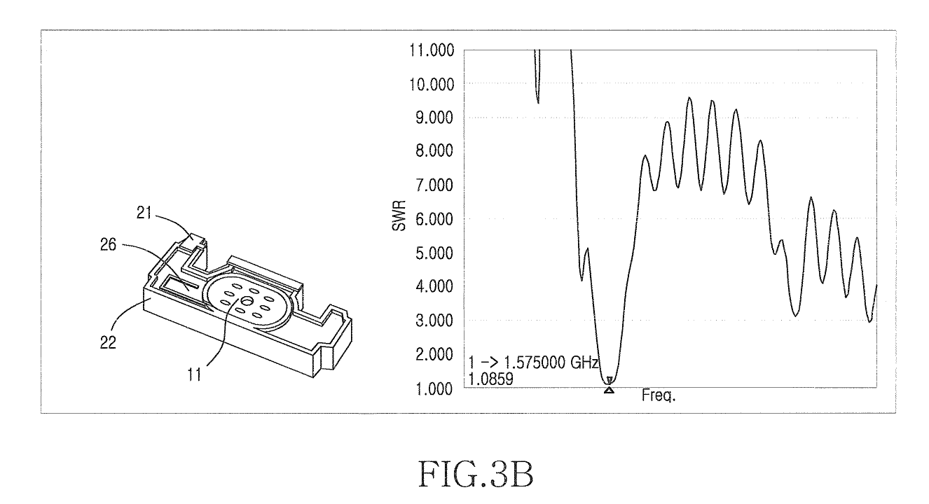

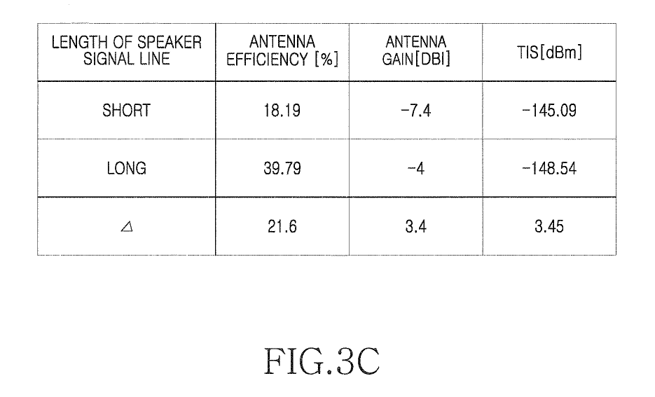

The speaker 11 may interfere with the antenna. For example, the speaker 11 fed from the main board generates resonance due to a factor such as a magnetic material, an internal coil, and such. The resonance generated from the speaker 11 deteriorates the performance of the antenna. More particularly, when the resonance generated from the speaker 11 occurs in a frequency band similar to resonance generated in the antenna, the antenna performance may deteriorate even more. To solve this problem, an embodiment of the present invention puts an emphasis on changing the shape and length of the signal line (or a feeding line) that electrically connects the speaker 11 with the main board. For example, when the length of the signal line connected to the speaker 11 increases, resonance generated from the speaker 11 changes. Generally, a device such as an inductor may be added inside the speaker 11. In this situation, however, compared to an embodiment of the present invention, it costs more, and a space for an additional device should be secured. A structure and a method for reducing interference between an antenna and a peripheral device according to an embodiment of the present invention are described below with reference to FIGS. 2 and 3.

FIG. 2 is a view of a structure for reducing interference between an antenna and a peripheral device according to an embodiment of the present invention.

Referring to FIG. 2, the antenna 21 is attached to a carrier 22 that has insulation, and the carrier 22 is seated on a main board of the mobile terminal 10. The antenna 21 is fed from the main board and also grounded to the main board, such that it may transmit/receive a radio wave. The main board is a substrate containing basic circuits and parts. The main board sets an execution environment of the mobile terminal 10, maintains information thereof, allows the mobile terminal to be stably driven, and allows all units of the mobile terminal 10 to swiftly perform data input/output exchange. The main board includes a controller (Central Processing Unit (CPU)), a microprocessor, an auxiliary processor, a memory, a BIOS, a connection circuit, and such. The main board includes a feeding unit for feeding electricity, and a grounding unit for grounding. Therefore, the antenna 21 may include a feeding pin that contacts the feeding unit of the main board, and a grounding pin that contacts the grounding unit of the main board. Accordingly, the antenna 21 is electrically connected with the feeding unit and the grounding unit of the main board to transmit/receive a radio wave.

Furthermore, the speaker 11 is fixed to the carrier 22 and is electrically connected to the main board. The carrier 22 inserts the speaker 11 therein to form a space where the speaker 11 resonates. The speaker 11 is inserted into the carrier 22, and the speaker 11 and the main board are electrically connected by the medium of the signal line 26. The signal line 26 is a cable or a Flexible Printed Circuit Board (FPCB), and is fixed to the carrier 22. The signal line 26 allows a current provided from the main board to flow through it. In addition, the signal line 26 allows a voice signal output from the main board to flow through it.

The antenna 21 and the speaker 11 may be fixed to a case frame forming an appearance of the terminal in substitution for the carrier 22.

The speaker 11 receives a signal from the main board via the signal line 26 to operate. As described above, because the speaker 11 includes a magnetic material and an internal coil, the speaker 11 resonates when driven. Such resonance of the speaker 11 may deteriorate the radiation performance of the antenna 21. According to an embodiment of the present invention, what is important is to resolve interference between the antenna 21 and the speaker 11 by changing the shape and the length of the signal line 26 electrically connected to the speaker 11.

FIGS. 3A, 3B and 3C are graphs that measure a Standing Wave Ratio (SWR) of a relevant antenna module depending on a length change of a signal line (feed line) of a speaker, and a table that compares antenna performances. According to an embodiment, the antenna module is used to resonate in a band of approximately 1.575 GHz, which is a Global Positioning System (GPS) resonance frequency, and may transmit/receive a radio wave in this band.

Referring to FIG. 3, when the length of the signal line 26 of the speaker module increases, resonance of the speaker antenna module moves to a low frequency region. That is, when the length of the signal line 26 of the speaker module increases, an SWR of the speaker antenna module approaches 1 in a band of 1.575 GHz.

In addition, as revealed from the table in FIG. 3, when the length of the signal line 26 of the speaker 11 increases, an antenna efficiency of the speaker antenna module increases by 21.6%, an antenna gain increases by 3.4 dB, and a GPS sensitivity (TIS) increases by 3.45 dB.

Though description has been made using a speaker as an example, the present invention is not limited thereto, and a peripheral device that interferes with the antenna may vary. The peripheral device may be a magnetic device or a vibrating device. For example, the peripheral device may be a microphone or a receiver.

Furthermore, the carrier, as suggested in an embodiment of the present invention, is not necessarily required and may be applicable to a module to which the peripheral device (ex: a speaker) and an antenna are coupled.

Consequently, a structure and a method for reducing interference between an antenna and a peripheral device according to an embodiment of the present invention may secure a radiation performance of the antenna.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A structure for reducing interference between an antenna and a peripheral device, the structure comprising:
an antenna module comprising a carrier and the antenna attached to the carrier; and
a speaker module mounted in the carrier and comprising a speaker and a signal line electrically connected to the speaker,
wherein the structure changes at least one of a shape and a length of the signal line to secure a radiation performance of the antenna module.

2. The structure of claim 1, wherein the speaker is inserted into the carrier and is configured to resonate.

3. The structure of claim 1, wherein the signal line comprises one of a cable and a Flexible Printed Circuit Board (FPCB).

4. The structure of claim 1, wherein the speaker includes a magnetic material and a coil.

5. The structure of claim 1, wherein the antenna module is included in a mobile communication device.

6. The structure of claim 5, wherein the signal line is configured to electrically connect the speaker to a main board of the mobile communication device.

7. the structure of claim 5, wherein the antenna and the speaker are each electrically connected a main board of the mobile communication device.

8. A structure for reducing interference between an antenna and a peripheral device, the structure comprising:
the peripheral device to which a signal line for receiving a signal is connected; and
the antenna influenced by the peripheral device and configured to transmit and receive radio waves,
wherein the antenna is configured to change a radiation performance as at least one of a shape and a length of the signal line changes.

9. The structure of claim 8, wherein the peripheral device comprises one of a speaker, a microphone, and a receiver.

10. The structure of claim 8, wherein the peripheral device comprises one of a magnetic device and a vibrating device.

11. The structure of claim 8, wherein the structure is insulated, and peripheral device and the antenna are fixed in the structure.

12. The structure of claim 9, wherein the structure comprises a case frame forming an appearance of a terminal.

13. The structure of claim 9, wherein the structure comprises a separately provided insulation carrier.

14. The structure of claim 8, wherein the antenna and the peripheral device are each electrically connected a main board.

15. A method for reducing interference between an antenna and a speaker, the method comprising:
measuring a radiation performance of the antenna; and
changing at least one of a shape and a length of a signal line electrically connected to a speaker to improve the measured radiation performance of the antenna.

16. The method of claim 15, wherein the antenna is attached to a carrier, and the speaker is mounted in the carrier.

17. The method of claim 15, wherein the signal line comprises one of a cable and a Flexible Printed Circuit Board (FPCB).

18. The method of claim 15, wherein the speaker includes a magnetic material and a coil.

19. The method of claim 15, wherein the antenna and the speaker are each electrically connected a main board.

20. The method of claim 15, the signal line electrically connects the speaker to a main board.
